(19) United States
(12) Patent Application Publication
(10) Pub. No.: US 2015/0009324 A1
(43) Pub. Date: Jan. 8, 2015

(54) IMAGE MONITORING SYSTEM AND METHOD WITH RADAR DETECTION

(71) Applicant: ELECTRONICS AND TELECOMMUNICATIONS RESEARCH INSTITUTE, Daejeon (KR)

(72) Inventors: Hyung Kyu LEE, Daejeon (KR); Soojong LIM, Daejeon (KR); Song-woo SOK, Daejeon (KR); Ok Gee MIN, Daejeon (KR); Kyoung PARK, Daejeon (KR)

(21) Appl. No.: 14/321,768

(22) Filed: Jul. 1, 2014

(30) Foreign Application Priority Data
Jul. 2, 2013 (KR) 10-2013-0077382

(51) Int. Cl. H04N 7/18

(52) U.S. Cl. CPC H04N 7/18
USPC 348/143

(57) ABSTRACT

An image monitoring apparatus is provided to monitor a wide area and accurately identify an object of surveillance based on radar technology. The monitoring area of a surveillance camera can be extended using radar, and an object to be detected can be accurately identified using fixed background information.

### CROSS-REFERENCE TO RELATED APPLICATION

This application claims priority to and the benefit of Korean Patent Application No. 10-2013-0077382 filed in the Korean Intellectual Property Office on Jul. 2, 2013, the entire contents of which are incorporated herein by reference.

### BACKGROUND OF THE INVENTION

(a) Field of the Invention

The present invention relates to an image monitoring system and a method for monitoring a monitoring area using radar technology.

(b) Description of the Related Art

Image monitoring systems such as a closed circuit television (CCTV) and a pan-tilt-zoon (PTZ) camera are widely used in modern society for the purpose of crime prevention, traffic safety, facility security, or the like. In addition, other products having different performance or forms have been developed depending on a variety of applications such as monitoring of roads, transportation, outer boundaries of crime-prone areas, and crime-prone areas, monitoring of the inside of a control building of an ubiquitous city (u-City), and the like.

Most cameras used in the image monitoring systems as described above are a fixed type. Thus, in order to monitor with no dead zone, it is necessary to increase the number of cameras and consider the monitoring range. To solve this problem, a multi-angle monitoring camera or a system that can change shooting directions has been developed.

These products are operated by allowing people to commonly adjust the angles of the camera or allowing the camera to rotate or move within a given range.

In addition, products mounted with an acoustic wave sensor, an infrared ray-heat detector, or products using an image recognition technology can perform an automatic motion tracking function.

However, since the image monitoring system is still sensitive to changes in the surrounding environment such as a noise, climate, brightness, and the like, improvement in the detection performance is difficult, and the cost of maintenance is high.

### SUMMARY OF THE INVENTION

The present invention has been made in an effort to provide an image monitoring apparatus having advantages of monitoring a wide area and accurately identifying an object of surveillance based on radar technology.

An exemplary embodiment of the present invention provides an image monitoring method using radar and a surveillance camera. According to an embodiment of the present invention, the image monitoring method may include: receiving information of an object located in a predetermined monitoring area from the radar; determining whether the object is a new object by comparing location information of the information with fixed background information of the monitoring area; and controlling the surveillance camera using the location information if the object is a new object.

In the image monitoring method, the controlling of the surveillance camera may include: inquiring a camera control policy on the object if the object is a new object; and determining whether the object is monitored according to the inquired control policy.

In the image monitoring method, controlling of the surveillance camera may include: controlling a monitoring direction of the surveillance camera using direction information of the location information, and operating zoom functions of the surveillance camera using distance information of the location information.

The image monitoring method may further include adding the location information to the fixed background information if the object is not a new object.

Another embodiment of the present invention provides an image monitoring system using radar and a surveillance camera. According to the current embodiment of the present invention, the image monitoring system may include: an antenna unit for detecting an object located in a predetermined monitoring area using the radar; a signal processing unit for grasping location information of the object; and a camera control unit for controlling the surveillance camera using the location information if the object is a new object after determining whether the object is a new object by comparing the location information with fixed background information of the monitoring area.

In the image monitoring system, the camera control unit may inquire a camera control policy on the object if the object is a new object; and determine whether the object is monitored according to the inquired control policy.

In the image monitoring system, the camera control unit may control a monitoring direction of the surveillance camera using direction information of the location information, and operate zoom functions of the surveillance camera using distance information of the location information.

In the image monitoring system, the camera control unit may add the location information to the fixed background information if the object is not a new object.

In the image monitoring system, the signal processing unit may grasp the location information using coordinate information of the monitoring area.

### BRIEF DESCRIPTION OF THE DRAWINGS

FIG. 1 is a diagram illustrating an image monitoring system according to an exemplary embodiment of the present invention.

FIG. 2 is a flowchart illustrating an image monitoring method of an image monitoring apparatus according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

The term “include” in the present specification does not exclude other components which are not described herein unless specifically disclosed otherwise, and may further include other components. Furthermore, the terms “. . . unit”, “. . . module”, and “. . . block” refer to a unit for processing at least one function or operation, and may be implemented by hardware, software, or a combination thereof.

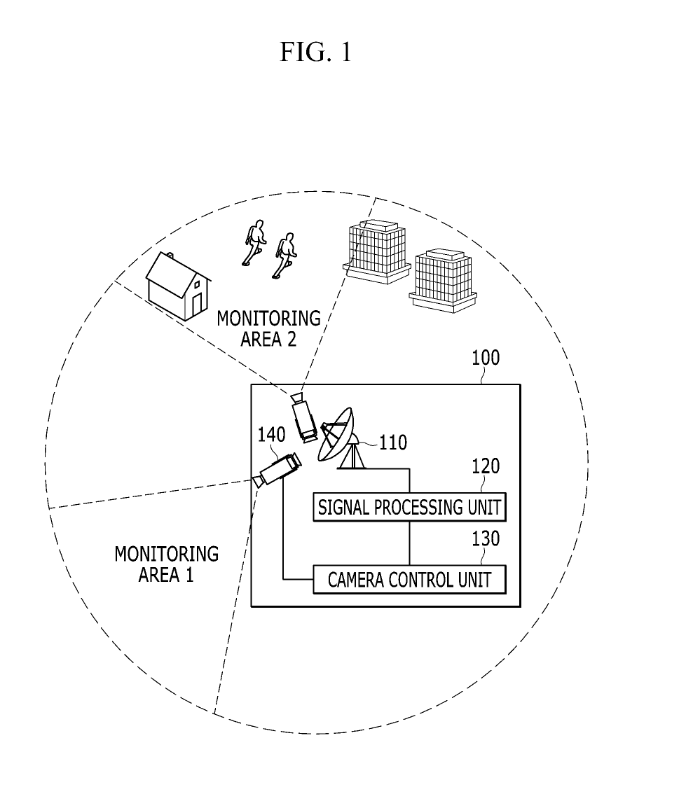

FIG. 1 is a diagram illustrating an image monitoring system according to an exemplary embodiment of the present invention.

Referring to FIG. 1, an image monitoring system 100 according to an exemplary embodiment of the present invention may include a radar antenna unit 110, a signal processing unit 120, a camera control unit 130, and a surveillance camera 140.

The radar antenna unit 110 can search a predetermined monitoring area using radar technology. Here, the radar antenna unit 110 can search the monitoring area using frequencies of an ultra-wideband (UWB) domain. If an object is detected in the monitoring area, the radar antenna unit 110 transmits detected signals to the signal processing unit 120.

The signal processing unit 120 finds location information of an object detected by the radar antenna unit 110. In other words, when the radar antenna unit 110 detects the object, the signal processing unit 120 indexes the detected object. Here, the signal processing unit 120 can grasp a relationship with an object to be detected at the time of next scanning by indexing the detected object. The signal processing unit 120 may index an object with a fast moving speed as a vehicle among the detected objects, and may index an object detected in a sidewalk area as a pedestrian. In addition, as a result of grasping the relationship with the object detected at the time of next scanning, objects determined to move out of the monitoring area may be indexed as non-risk object groups.

Subsequently, the signal processing unit 120 finds distance and direction information related to the detected object using coordinate information of the monitoring area, and transmits the distance and direction information related to the detected object to the camera control unit 130.

The camera control unit 130 moves the surveillance camera 140 so that the monitoring area may be changed and a specific point of the monitoring area may be intensively monitored. Referring FIG. 1, the surveillance camera 140 monitoring a monitoring area 1 can monitor a monitoring area 2 according to the control of the camera control unit 130.

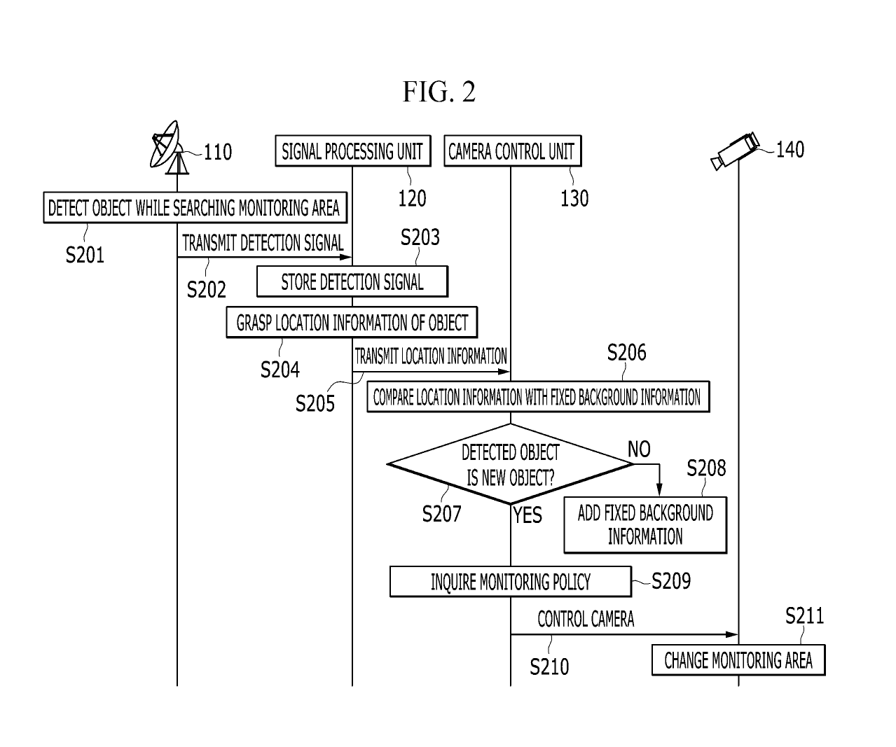

FIG. 2 is a flowchart illustrating an image monitoring method of an image monitoring apparatus according to an exemplary embodiment of the present invention.

Referring to FIG. 2, firstly, the radar antenna unit searches a predetermined monitoring area, and transmits detection signals of the object detected in the monitoring area to the signal processing unit in real time (S201, S202). Subsequently, the signal processing unit stores the detection signals in a database, and grasps location information of the detected object by mapping the detected signals and coordinate information of the monitoring area (S203, S204).

Subsequently, the camera control unit receives the location information of the detected object (S205), and determines whether the detected object is a new object by comparing the location information of the detected object with fixed background information of the monitoring area (S206). Here, the image monitoring system according to an exemplary embodiment of the present invention can accurately identify an object to be detected using the fixed background information. In general, the scanning result of the radar includes a lot of noise. Here, when noise is removed using a filtering algorithm, many computing resources may be consumed in algorithm operations. Accordingly, in the exemplary embodiment of the present invention, the noise can be removed using fixed background information such as building or roads in the monitoring area.

As a result of the comparison of the location information of the detected object and the fixed background information of the monitoring area (S207), when the detected object is determined to not be a new object, the detected object is added to the fixed background information (S208).

However, as a result of the comparison of the location information of the detected object and the fixed background information of the monitoring area, when the detected object is determined to be a new object, a monitoring policy on the detected object is inquired (S209). For example, if the detected object is a new object, and the detected object is accessed within a certain range as a result of the indexing, a policy to intensively monitor the detected object may be applied.

As a result of inquiry of the monitoring policy, if the detected object is an object to be intensively monitored through the camera, the camera control unit may move the camera to monitor a point at which the detected object is located (S210), and the surveillance camera may change the monitoring area (S211). Here, the camera control unit may rotate the camera based on direction information of the detected object and implement zoom-operations based on the distance information.

According to an exemplary embodiment of the present invention as described above, the monitoring area of the surveillance camera can be extended using the radar, and an object to be detected can be accurately identified using the fixed background information.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An image monitoring method using radar and surveillance camera, the method comprising:
receiving information of an object located in a predetermined monitoring area from the radar;
determining whether the object is a new object by comparing location information of the information with fixed background information of the monitoring area; and
controlling the surveillance camera using the location information if the object is a new object.

2. The method of claim 1, wherein the controlling of the surveillance camera includes:
inquiring a camera control policy on the object if the object is a new object; and
determining whether the object is monitored according to the inquired control policy.

3. The method of claim 1, wherein the controlling of the surveillance camera includes
controlling a monitoring direction of the surveillance camera using direction information of the location information, and operating zoom functions of the surveillance camera using distance information of the location information.

4. The method of claim 1, further comprising adding the location information to the fixed background information if the object is not a new object.

5. An image monitoring system using radar and surveillance camera, the system comprising:
an antenna unit for detecting an object located in a predetermined monitoring area using the radar;
a signal processing unit for grasping location information of the object; and
a camera control unit for controlling the surveillance camera using the location information if the object is a new object, after determining whether the object is a new object by comparing the location information with fixed background information of the monitoring area.

6. The system of claim 5, wherein the camera control unit inquires a camera control policy on the object if the object is a new object, and determines whether the object is monitored according to the inquired control policy.

7. The system of claim 5, wherein the camera control unit controls a monitoring direction of the surveillance camera using direction information of the location information, and operates zoom functions of the surveillance camera using distance information of the location information.

8. The system of claim 5, wherein the camera control unit adds the location information to the fixed background information if the object is not a new object.

9. The system of claim 5, wherein the signal processing unit grasps the location information using coordinate information of the monitoring area.
